(19) United States
(12) Patent Application Publication
(10) Pub. No.: US 2004/0073694 A1
(43) Pub. Date: Apr. 15, 2004

(54) Network resource allocation and monitoring system

(76) Inventors: Michael Frank, Karnei Shomron (IL); Alexander Segalovitz, Kfar Saba (IL); Elena Brodsky, Hod Hasharon (IL)

Correspondence Address: Edward Langer, Shiboleth Yisraeli Roberts & Zisman & Co, 60th Floor, 350 Fifth Avenue, New York, NY, 10118, US

(21) Appl. No.: 10/432,838

(22) PCT Filed: Nov. 30, 2001
(86) PCT No.: PCT/IL01/01109

(51) Int. Cl. G06F 15/16

(52) U.S. Cl. 709/232; 370/412

(57) ABSTRACT

A network comprises a frame delivery schedule system for weighting and timing the delivery of frames from flows according to user-definable policies. The frame delivery schedule system comprises a scheduler, a schedule queue, and a policy database. The scheduler comprises an algorithm whereby each queued flow is weighted at least once and wherein a flow having frames waiting to be sent is re-weighted after one of its frames is sent.

### CROSS REFERENCE TO RELATED APPLICATIONS

The present application claims the priority of U.S. Provisional Patent Application No. 60/250,086, filed Nov. 30, 2001, the contents of which are hereby incorporated by reference in their enirety.

### FIELD OF THE INVENTION

The present invention relates to a method for the computer network resource allocation. More particularly, the present invention relates to a system for providing Quality of Service in network bandwidth allocation.

### BACKGROUND OF THE INVENTION

Computer means for communicating outside of a LAN, such as between different LANs or domains, or interdomain services, are provided by providers. The providers provide LANs with means permitting ingoing and outgoing communication between wide area networks, (hereinafter “WAN”), e.g. World Wide Web communication service. The inter domain communications traffic service is provided by internet service providers, (“ISP” hereinbelow). The ISP-provided communications means, which include hardware such as routers, servers and bridges, and software for their operation, are used for the handling of queried data originating in domains external to the querying LAN, and for the use of applications residing externally to the using LAN. The WAN communication means are usually provided by each ISP to, and are shared by, numerous users, which typically include many LANs.

Two of the main problems faced by ISPs are:

IP/TCP which forms the base of the WAN were originally written to handle a far more limited traffic than is currently required; and

The original requirements from the communication protocols were much more limited in scope than is now essential for the proper utilization of the ISP network resources, which are limited compared to the users demands.

An important goal of the ISP is to permit an optimal utilization of his communication resources by optimizing their allocation among its users. As the users' utilization of the network varies continuously, the ISP preferably has to monitor regularly the use of the resources, dynamically reallocating them among the users. This is especially so where an ISP has contractually committed to any or all of its customers one or varied bandwidth allocations.

It may also be desirable that a LAN administrator be able to implement a corporate policy for allocating bandwidth of the available communication resources among his LAN users, which may include both the LAN internal resources and the WAN resources provided by the ISP.

Without an implementation of a corporate policy at the level of the LAN administrator, the WAN resources allocated and provided by the ISP to each LAN, as well as the internal LAN resources, are used by the LAN users, who compete for their shares in them. An optimal implementation of the LAN and the WAN resource allocation policies calls for the determination and the enforcement of priorities among the LAN users.

Today, establishing or enforcing systems and methods are not based either on comprehensive set of criteria and on network data and metrics for priority establishment, or on the multi-tiered grouping of connections.

For example U.S. Pat. No. 6,006,264, to Steven Colby et al, suggests a method and a system for directing a flow between a client and a server within a servers farm, based only on the servers' current load and their load history, and on the packet content, content being defined in '264 as any information that a client application is interested in receiving. No criteria other than those listed hereinabove, such as those regarding time of use, emergencies and others, are taken into consideration by Colby et al.

PCT Publication No. WO99/27684, published Jun. 3, 1999 discloses a method for automatically classifying traffic in a packet comunications network by assigning rules of service level.

PCT Publication No. WO99/46902, published Sep. 16, 1999, discloses a method for minimizing queueing in a network by “fooling” the sending computer into reducing its window size.

Other methods and systems using a limited set of criteria, factors and metrics exist. For example, traditional queuing and TCP-based methods for the control of communication traffic between WAN and LAN exist. The queuing approach is good at optimizing outgoing traffic, offering good control of communication traffic from fast LAN to a typically much slower WAN. While TCP rate control methods are optimal for controlling incoming traffic from a WAN connection to a LAN connection, they are not optimal for outgoing traffic.

Another drawbacks that the existing traffic control and resource allocation methods suffer from the fact that none of the presently known methods permits the use of a policy, i.e. a comprehensive set of criteria, selectable and controllable by the system or the network administrator, for the optimal resource allocation to users within a LAN and among different LANs, as elaborated hereinbelow.

Still another drawback of the existing systems and methods is that their implementation often calls for extensive changes in the communication infrastructure. No such changes are required by this inventive system.

Yet another drawback of the existing systems and methods is that the methods used for the application of their criteria call for the use of massive computing power, consequently only small number of criteria can be practically used. This inventive system uses methods, which substantially decrease the required computing power and therefore permit the use of numerous criteria.

Resource allocation methods involve the use of prioritizing and queuing methods, calling for the application of fast prioritizing and queuing methods as a precondition for their efficient use. While many existing routers use various queuing algorithms, such as weighed-fair queuing or class-based queuing, and while the queuing algorithms in use might provide fair resource allocation among different priority classes, they fail to provide a consistent fairness policy among flows within the same class.

Furthermore, it is often necessary for the system administrator or for supervisory staff to monitor the various applications used by the LAN users and to verify that only certain classes or groups of tasks are used, or that certain tasks, URL's and the like are excluded.

Therefore a need arises to continuously monitor and dynamically allocate the communication resources both by the ISP to each LAN, and within each LAN's according to the LAN administrator policy, the policy being based on a large number of controllable and modifiable and dynamic criteria.

### SUMMARY AND OBJECTS OF THE INVENTION

Thus the present invention has the following as its objectives, although this following is not exhaustive.

It is a purpose of the present invention to provide a computerized system and a method for the enforcement of a comprehensive, flexible, controllable and dynamically applied multi-tiered policy, for the determination of actions based on policy determined priorities used for the allocation of communication resources among network users, said action includes the binding of equal priority connections into sub-groups to be equally handled according to a rule applied to said sub-group, and the assembling of said sub-groups of a particular LAN into a group to which the LAN's communication resources are allocated and in which they are divided among said sub-groups, according to a policy. This inventive system and method is referred to hereinbelow as Policy Enforcer, abbreviated to PE.

Alternatively, a purpose of this invention can be viewed as the dynamic and equitable allocation of communication resources to pipes allocated to LANs, naming, grouping each group of equal priority connections of a user in a rule.

Another purpose of this invention is the provision of guaranteed Service Quality to users, determined by a selectable policy, said policy being determined by other means or method.

Still another purpose of the present invention is the optimization of the network resources utilization.

Yet another purpose of this invention is the provision of centralized network monitoring and accounting services.

The implementation, the enforcement and the optimization referred to hereinabove are achieved by use of specialized hardware and software and the application of the (steps)/(operations) elaborated hereinbelow:

(a) The comprehensive monitoring of IP network properties, of its users, of its communication traffic and of their metrics and other data, for the establishment of selectable and controllable communication priorities by this inventive system authorized personnel based on the abovementioned monitored metrics and data. The above-mentioned network metrics, properties and data are referred to hereinbelow as Network Usage Properties, abbreviated as NUP.

(b) The application and the enforcement of communications resource allocation policy having as its input administrative decisions as well as said monitored network metrics and data.

(c) The establishment of procedures for banding of equally handled communicated items, and for the optimization of traffic control, therefore establishing a multi-tiered division of communicated items and of procedures for the handling of each tier.

(d) Accessing Directory Data-base storing policy information.

(e) The monitoring and the recording of network usage by authorized personnel. The authorized personnel are referred to hereinbelow as supervisors.

(f) Policing, such as access control, including remote login and user authentication.

(g) Server resource control, including cache redirection and server selection.

(h) Tagging such as header field tagging.

The NUP are used in this inventive system in a manner selectable by supervisors for the allocation of network resources to both individual users within LAN's and among different LAN's, according to controllable algorithms having as input the abovementioned NUP.

A PE enforces network policies in conjunction with other inventive systems. A PE can be incorporated in one or more units of hardware and software, and it applies network policies determined by another inventive system named hereinbelow Policy Manager, abbreviated as PM.

The PE may reside in a router or it may form a specialized equipment unit or units. It is controlled by PM and makes decisions based on the PM output. The enforcement can be done by checking of a single tag in a packet, or it may be applied by a dedicated equipment that analyzes traffic and performs network actions such as:

The PM unit permits the inputting of external and internal administrative and other policy information, and translates it into network terminology to be used by the PE. The PE may by supplied pre-configured for most standard protocols and applications, and it can also be custom configured to fit any special requirements.

### BRIEF DESCRIPTION OF THE FIGURES

The present invention may be better understood with reference to the detailed description which follows when taken together with the drawings which are briefly described as follows:

FIG. 1 is a block diagram of a system including an exemplary embodiment of the present invention;

FIGS. 2a and 2b show flow diagrams illustrating a policy enforcer system and its place in a network structure in accordance with an exemplary embodiment of the present invention;

FIG. 3a showing an illustration of a network being handled in accordance with a network administrator-defined policy in accordance with an exemplary embodiment of the present invention;

FIGS. 3b-3d showing screenshots of an enforcement policy creation and management software module 36 in accordance with an exemplary embodiment of the present invention;

FIGS. 4a-4f show flow diagrams and block diagrams illustrating a QoS scheduler and its components and products in accordance with an exemplary embodiment of the present invention;

FIG. 5 is a general block diagram of the PE software and of its relationship with the classifier unit in accordance with another exemplary embodiment of the present invention;

FIG. 6 is a more detailed block diagram of this PE software and of its relationship with its QoS module software in accordance with the exemplary embodiment shown in FIG. 5;

FIG. 7 is a block diagram of this PE QoS software in accordance with the exemplary embodiment shown in FIG. 5;

FIG. 8 is a detailed block diagram of this PE QoS software frame handling in accordance with the exemplary embodiment shown in FIG. 5;

FIG. 9 is a detailed block diagram of this PE inventive QoS software pipe handling in accordance with the exemplary embodiment shown in FIG. 5; and

FIG. 10 is a detailed block diagram of this PE inventive QoS software “send” handling in accordance with the exemplary embodiment shown in FIG. 5.

### DETAILED DESCRIPTION OF THE INVENTION

In the detailed description of exemplary embodiments which follows, the following terms should generally be understood as specified hereinbelow unless otherwise specified:

Interface—total amount of potential bandwidth available for being managed by the system of the present invention within a particular network.

Flow or connection—a series of frames having common attributes.

Flow attributes—fields of frame header(s) that appear in each frame of the flow. Basic flow attributes include Network Protocol; Transport Protocol, source and destination IP addresses (in case of IP); and source and destination ports (in case of TCP and UDP). There can be additional flow attributes, such as ToS byte in IP frames.

Virtual Channel (VC)—a group of flows that share common attributes and have a common QoS policy.

Pipe—a group of VCs whose underlying flows share common attributes. All flows under a pipe share the pipe's QoS policy.

QoS policy—a set of parameters that reflect the user's wish regarding bandwidth allocation.

Each pipe policy can be characterized by the following parameters:

Minimum pipe BW.

Maximum pipe BW

pipe priority.

Each VC policy can be characterized by the following parameters:

Minimum VC BW.

Maximum VC BW

VC priority

Minimum flow BW.

Maximum flow BW

Time slice—a time interval over which QoS definitions are enforced.

Scheduling timeout—maximum time interval between invocations of QoS Scheduler.

Send Queue of a flow—a FIFO queue of frames that belong to the flow, waiting to be transmitted.

Max Queue—the queue of flows that temporarily cannot transmit because of a Maximum restriction.

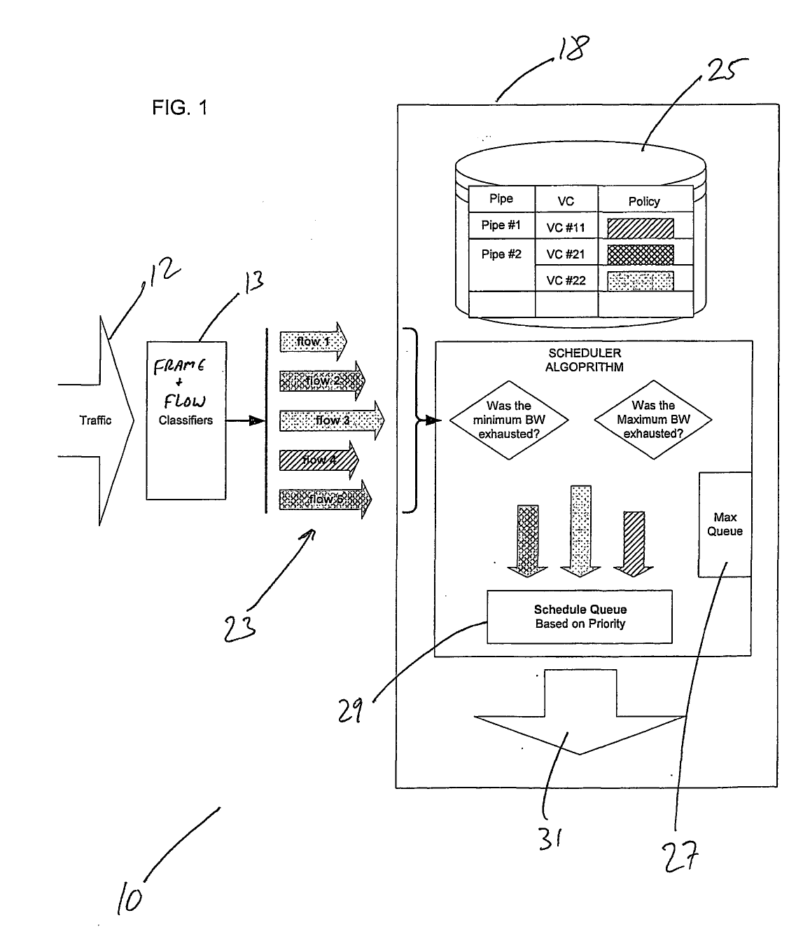

The following definitions and rules apply specifically with respect to the exemplary embodiment shown with reference to FIGS. 1-4f and described hereinafter.

Active Connection is a connection that has frames in the current time slice.

Active VC is a VC that has underlying active connections.

Active Pipe is a pipe that has underlying active VC.

Weight of a VC or Pipe is inverse to it's priority, i.e. for priorities 1, 2, 3 . . . 10, the corresponding weights are 10, 9, 8 . . . 1 (that is, weight(x)=11−x).

Actual weight of a VC or Pipe is a function of its weight: the higher the weight is, the lower is the actual weight. For weights 1, 2, 3 . . . 10, actual weight(x)=2520/x (2520 is the lowest common multiple of all possible weights).

Total weight of a Pipe equals the sum of actual weights of underlying active VCs.

Total weight of an Interface equals the sum of actual weights of underlying active pipes.

Allocated BW of a VC equals its minimum—if minimum is defined, or the total minimum of the underlying active connections otherwise.

Allocated BW of a Pipe equals its minimum—if minimum is, or the total allocated BW of the underlying active VCs otherwise.

Allocated BW of an Interface equals the total allocated BW of underlying active pipes.

Spare BW of an Interface equals its total BW minus allocated BW.

Spare BW of a Pipe equals its minimum minus total allocated BW of the underlying active VCs—if minimum is defined, or zero otherwise.

Spare BW of a VC equals its minimum minus total allocated BW of the underlying active connections—if minimum is defined, or zero otherwise.

Priority BW of an Interface equals its spare BW.

Priority BW of a Pipe is derived from the priority BW of the parent Interface:

PIPE PRI BW=IF PRI BW*PIPE ACTUAL WEIGHT/IF TOTAL WEIGHT,

Priority BW of a VC is derived from the priority BW of the parent pipe:

VC PRI BW=PIPE PRI BW*VC ACTUAL WEIGHT/PIPE TOTAL WEIGHT,

Total BW of a Pipe equals its allocated BW plus its priority BW. If Pipe total BW exceeds pipe's maximum, it is reduced to pipe's maximum.

Total BW of a VC equals its allocated BW plus its priority BW plus its share of parent pipe's spare BW (according to VC's priority). If VC total BW exceeds VC's maximum, it is reduced to VC's maximum.

Total BW of a Connection equals its minimum plus its share of parent VC's priority BW plus its share of parent VC's spare BW (all active connections get an equal share). If Con total BW exceeds connection's maximum, it is reduced to connection's maximum.

Scheduling weight of a Connection equals the number of bytes the connection has sent in the current time slice, if connection has not exceeded its minimum. Otherwise, it equals the number of bytes the connection has sent above its minimum, plus a weight factor (see below).

Scheduling weight of a VC equals the number of bytes the VC has sent in the current time slice, if VC has not exceeded its allocated BW. Otherwise, it equals the number of bytes the VC has sent above its allocated BW multiplied by VC's weight, plus a weight factor (see below).

Scheduling weight of a Pipe equals the number of bytes the pipe has sent in the current time slice, if pipe has not exceeded its allocated BW. Otherwise, it equals the number of bytes the pipe has sent above its allocated BW multiplied by pipe's weight, plus a weight factor (see below).

Weight factor is an integer big enough to enable a clear distinction between entities that are below and above their allocated BW, for example, 2\hat{ }31.

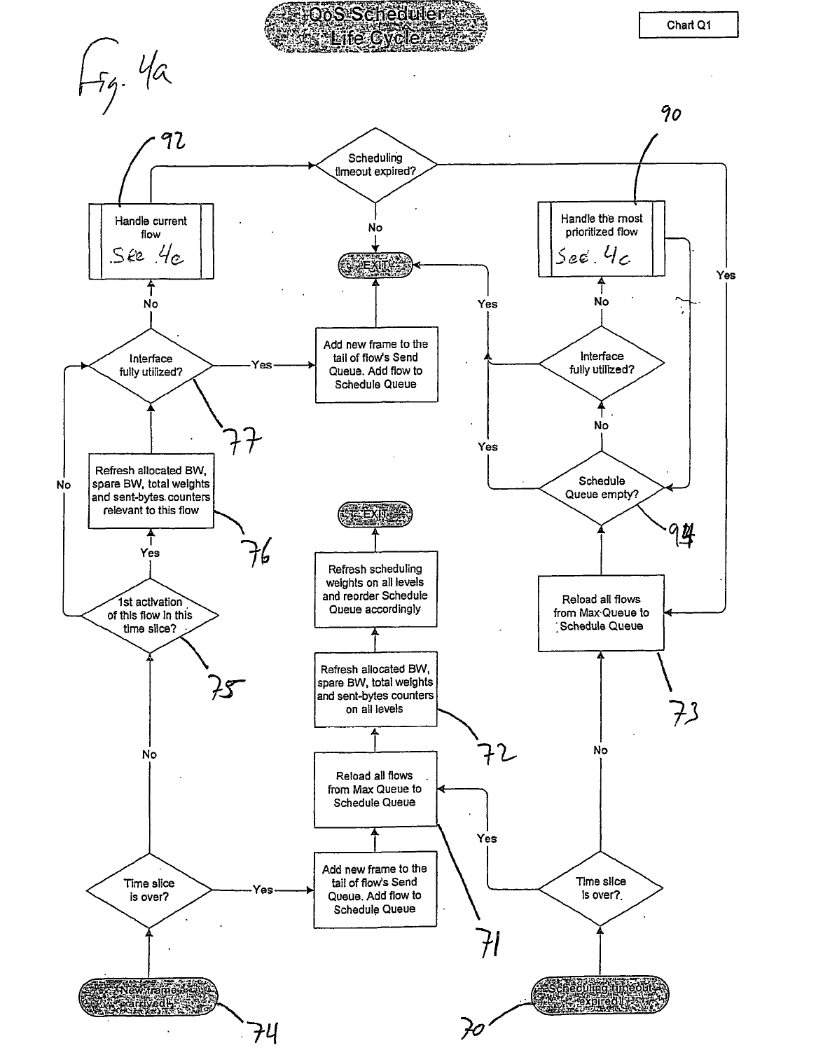

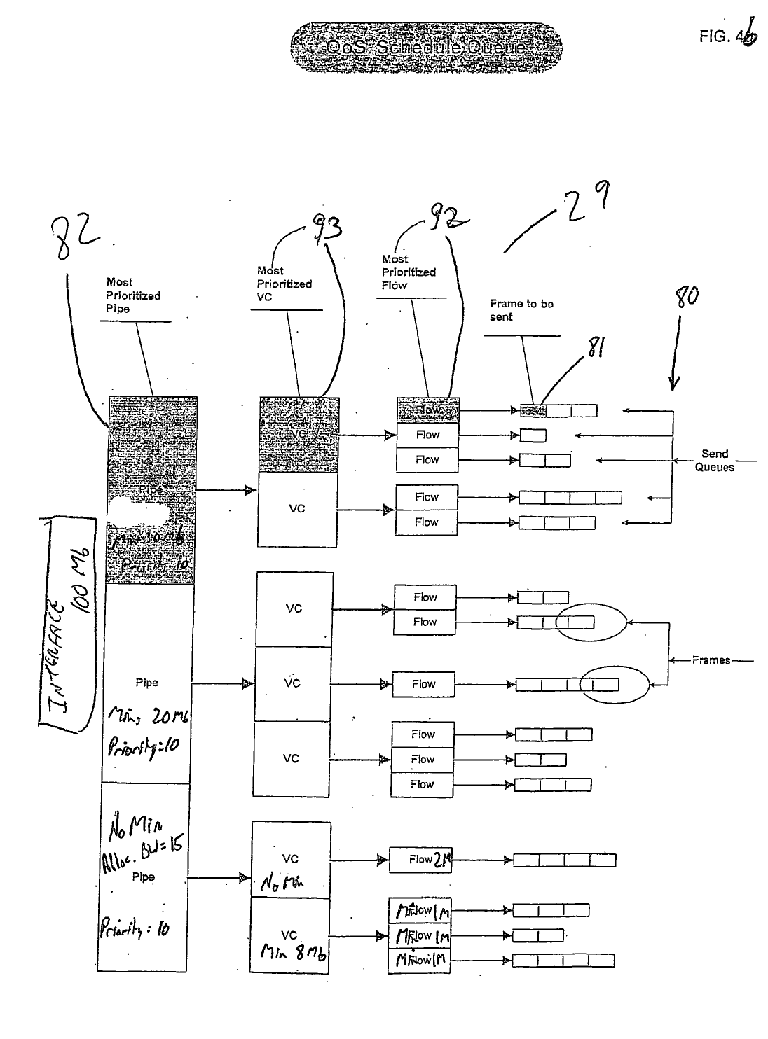

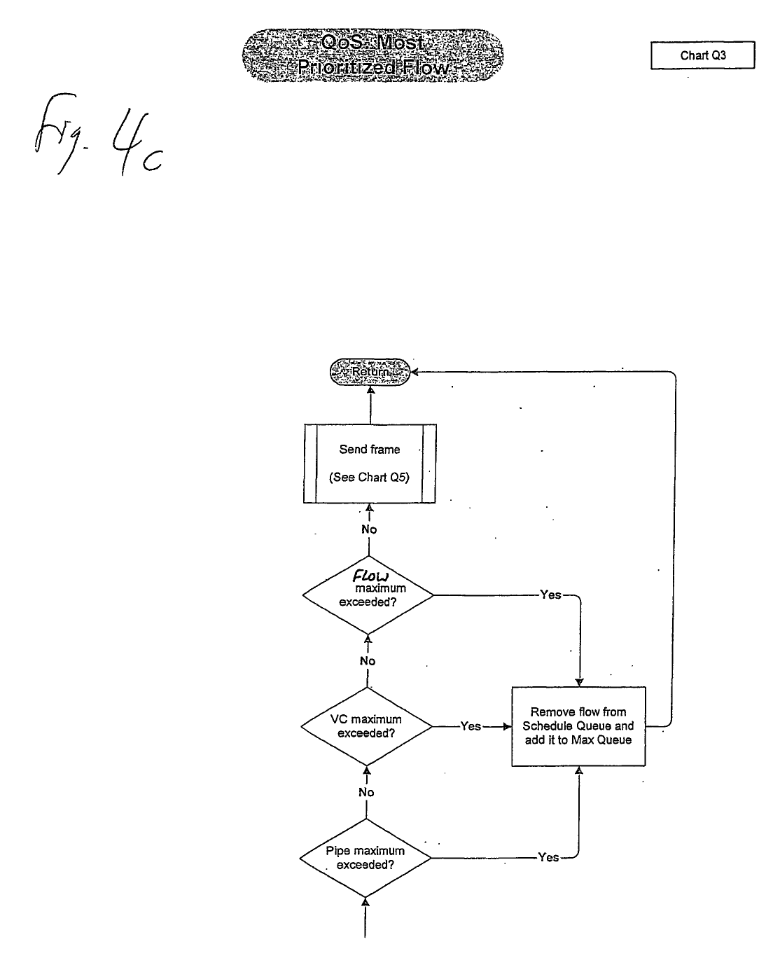

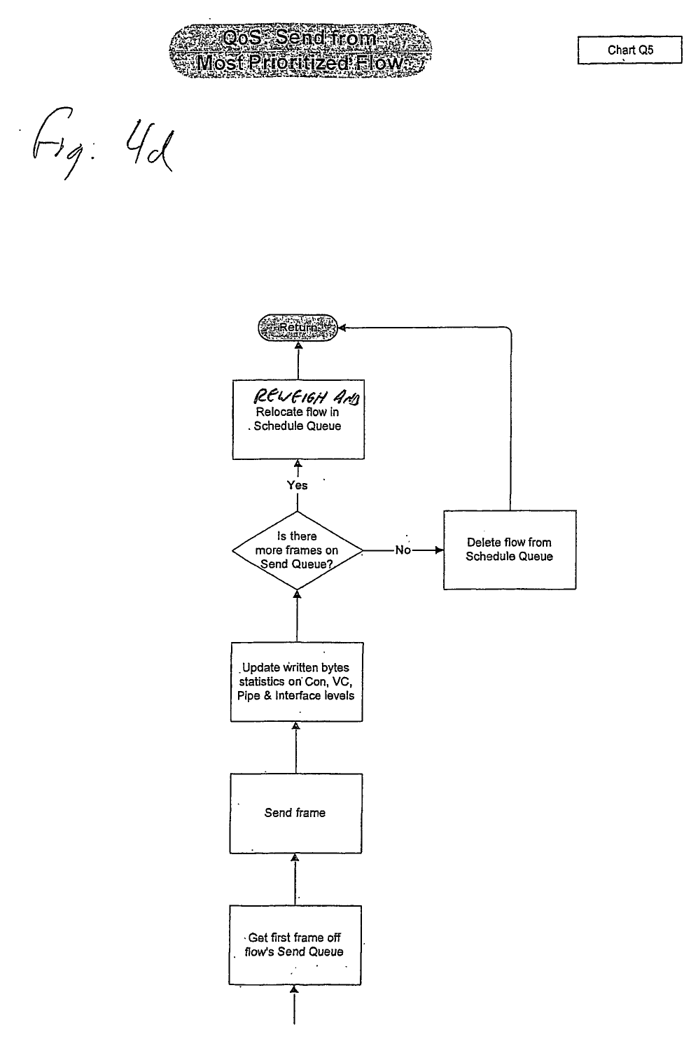

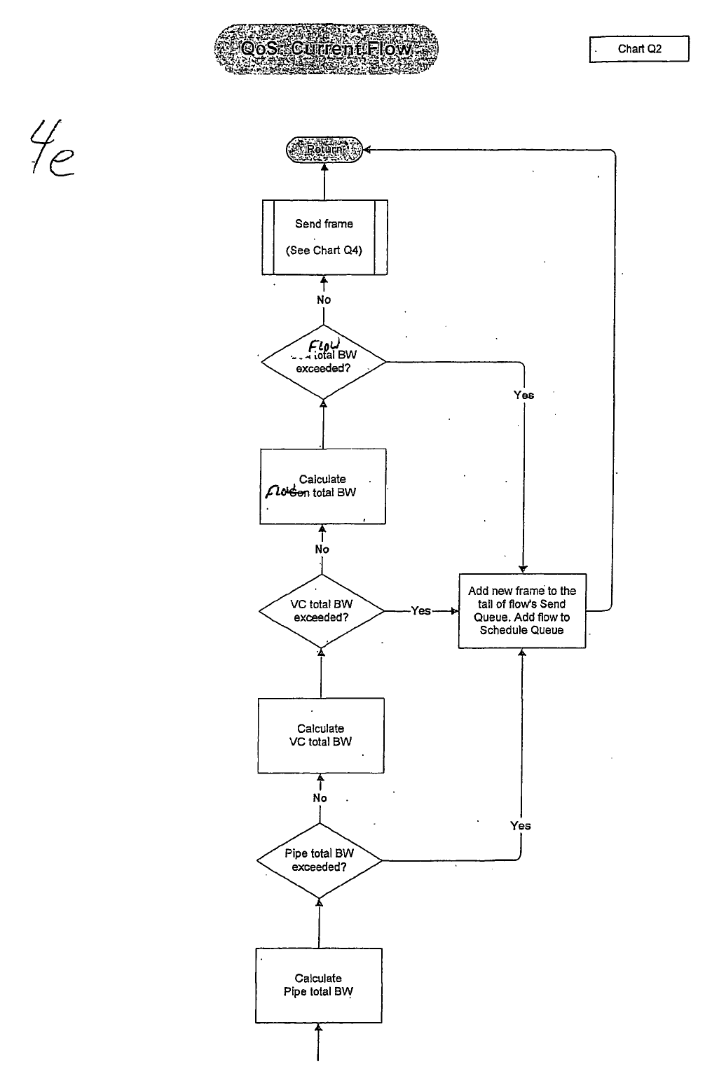

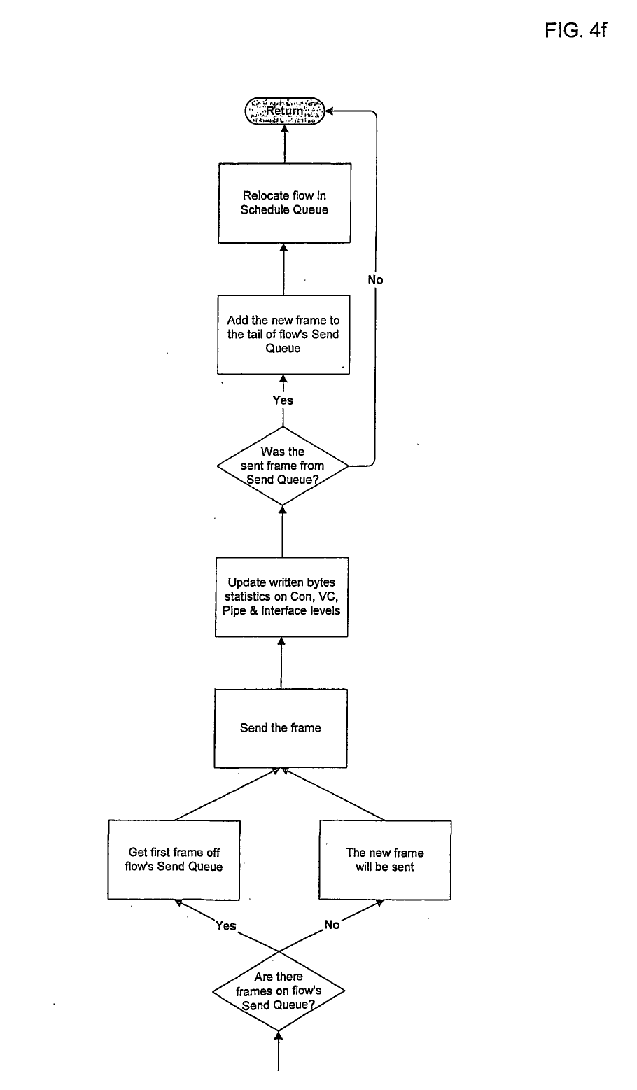

Schedule Queue is a three-layered structure (FIG. 4b), where the upper layer is a queue of active pipes, ordered according to their scheduling weights. Under each pipe, there is a queue of underlying active VCs, ordered according to their scheduling weights. And under each VC, there is a queue of underlying active flows ordered according to their scheduling weights. Each time a flow is added to the Schedule Queue, its scheduling weight is recalculated. The scheduling weights of its parent VC and ancestor pipe are also recalculated, and they are inserted (or relocated) accordingly, if needed.

Most prioritized pipe—the pipe with the lowest scheduling weight.

Most prioritized VC—the VC with the lowest scheduling weight, within the most prioritized pipe.

Most prioritized flow—the flow with the lowest scheduling weight within the most prioritized VC.

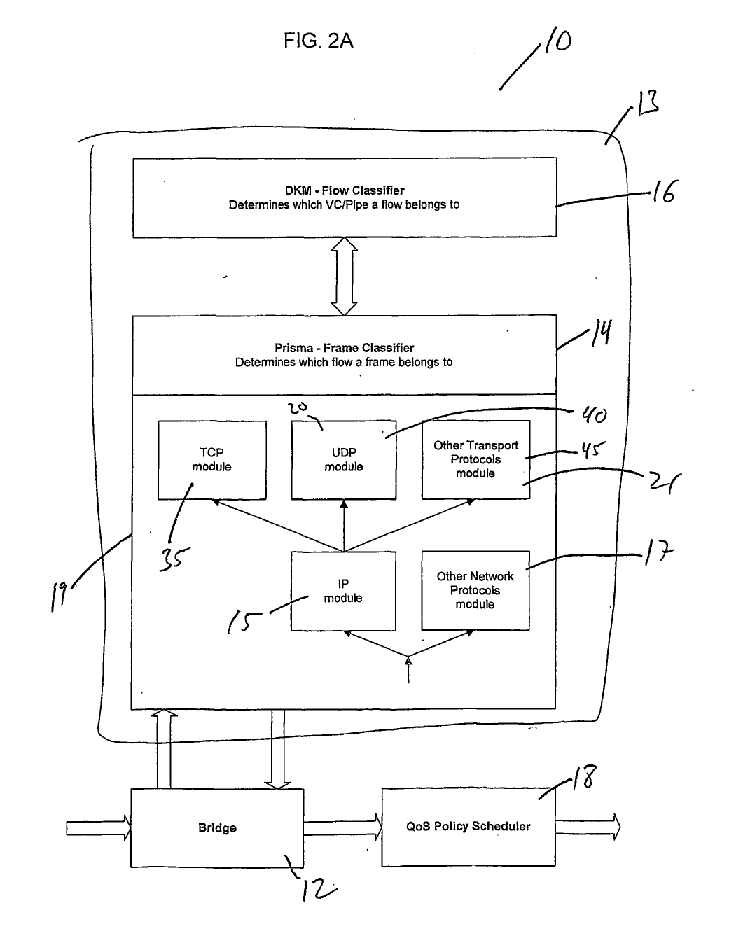

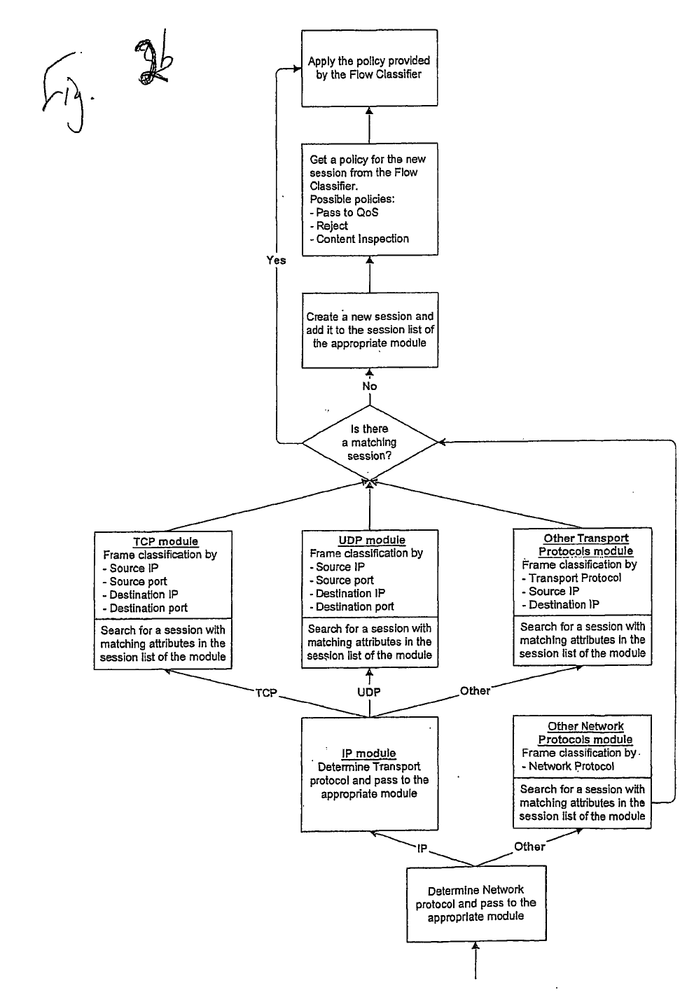

With reference to FIGS. 1, 2a and 2b, there is shown an overview of a policy enforcer 10 which could be employed in a network environment 11 in accordance with an exemplary embodiment of the present invention.

Each frame that enters the policy enforcer 10 is first processed by a bridge 12. If bridge 12 decides to forward the frame, the frame is passed to classifiers 13, comprising frame classifier 14 and flow classifier 16. Frame classifier 14 first identifies the network protocol of the frame and forwards the frame to either the IP module 15 or other network protocol (e.g. ARP or IPX) modules 17. If the frame is in IP Network protocol, then IP module 15 determines the Transport protocol of the frame and forwards the frame to the appropriate transport protocol module 19, 20 or 21. Frame classifier 14 also looks up the flow 23 which the frame belongs to in a list of flows of the appropriate module 17, 19, 20 or 21. In case there is no matching flow, frame classifier 14 creates a new flow and asks flow classifier 16 to match the flow 23 to an appropriate VC/Pipe (i.e. a policy) by looking up the VC and pipe definitions stored in policy database 25.

The frame is then put into the appropriate flow and is passed to scheduler 18, which determines when to transmit the frame according to a QoS policy using a per-flow queuing method described hereinbelow with reference to FIGS. 4a-4h.

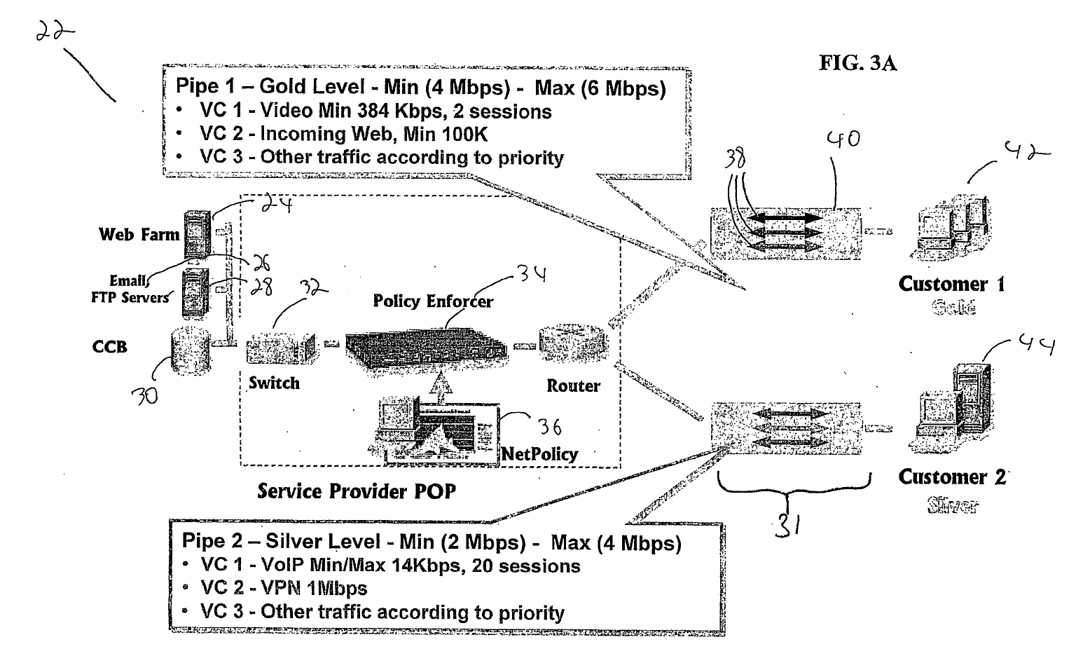

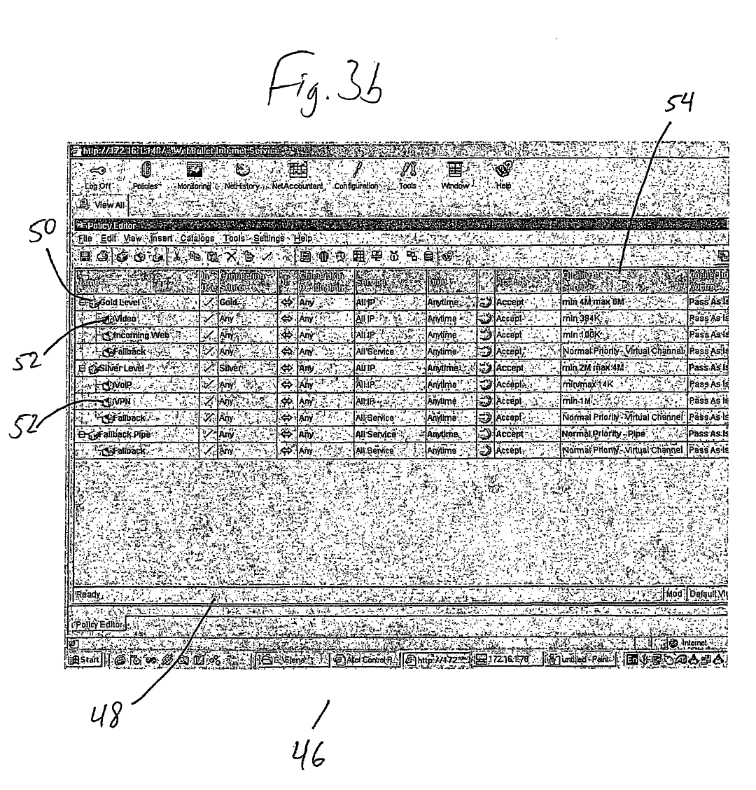

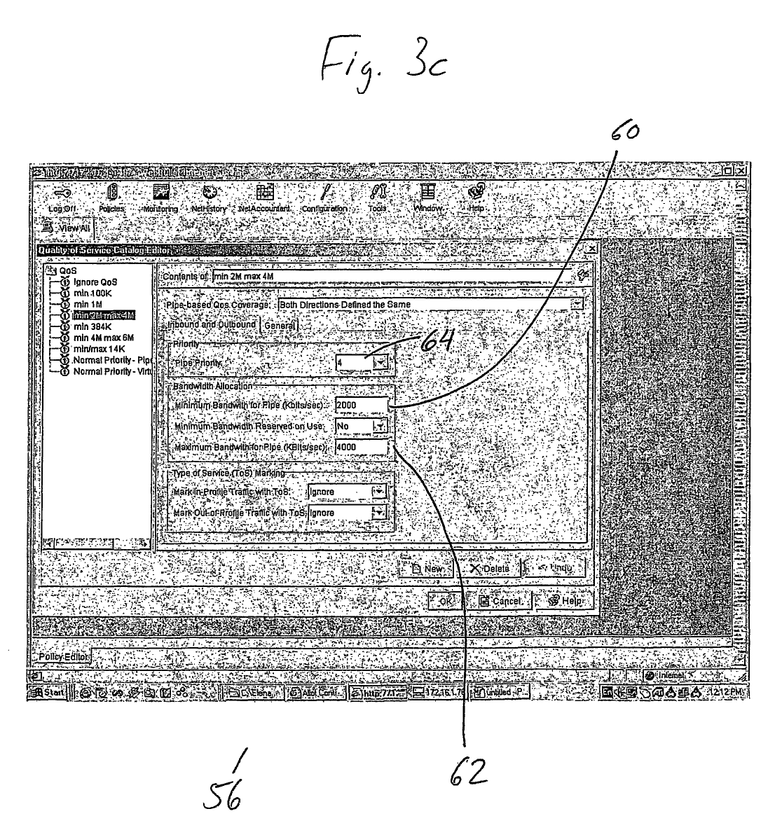

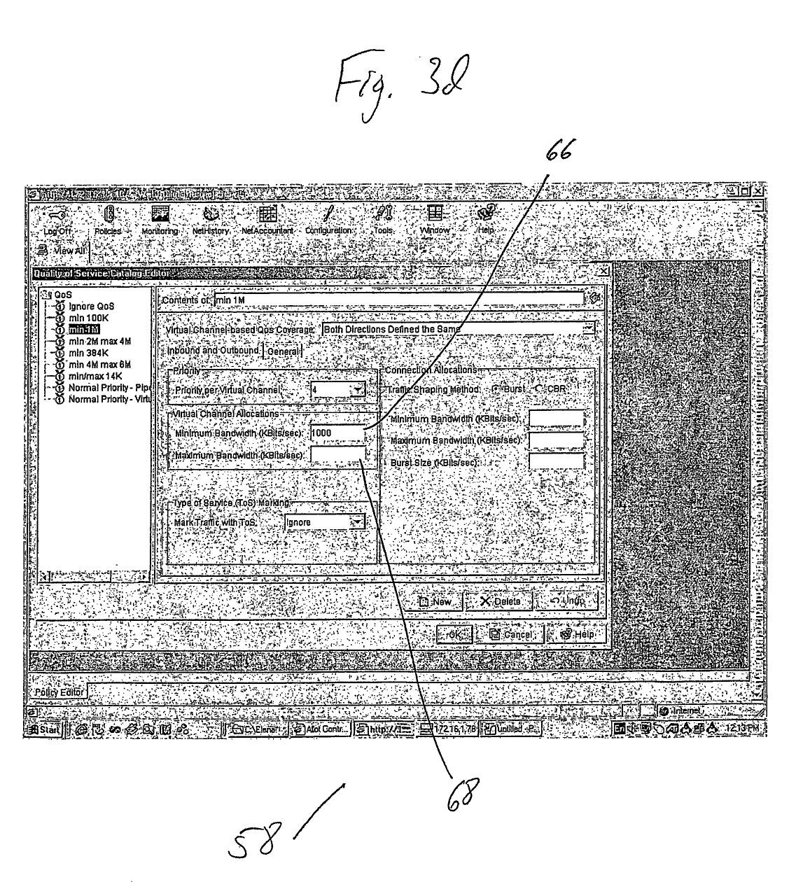

With reference to FIGS. 3a-3d, there is seen a schematic drawing of a QoS equipped network 22, showing the stream of connections (flows) from such services as Web farms 24, E-mail 26 and FTP servers 28 and CCBs 30, passing through a Service Provider's switch 32 into a policy enforcer 34, which contains and implements the policies promulgated by an enforcement policy creation and management software module 36. Policy enforcer 34 classifies flows into VCs 38 which are grouped into pipes 40 and delivered to “Gold” users 42 and “Silver” users 44, according to the QoS enforcement policy.

With reference to FIG. 3b, a screen shot 46 of an exemplary embodiment of an enforcement policy creation and management software module 36 shows the parameter input user screen 48 which may be used to create or modify QoS enforcement policies to be implemented by policy enforcer 34. By setting the parameters, which are presented in a hierarchy similar to a file manager tree directory, a user can create or modify a pipe 50, below which are designated VCs 52. The fields for each line headed by a VC designation represent the parameter settings for flows which should be considered as part of that VC, parameters including connection source, connection destination, service, time, etc. Of note for the present invention, is the button marked Quality of Service 54, which when activated brings up at least one of two secondary windows 56 and 58, seen in FIGS. 3c and 3d respectively, in which a user can define QoS properties of a pipe or the underlying VCs making up a pipe. Properties which the scheduler 18 works with are the minimum 60 and maximum 62 bandwidth allocation settings for a pipe, the priority setting 64 of the particular pipe with respect to other pipes, e.g on a scale of 10 (highest) to 1 (lowest), minimum 66 and maximum 68 bandwidth allocation settings for the particular VC, and the priority setting of the particular VC with respect to other VCs and minimum and maximum BW allocation settings for connections (flows) belonging to the particular VC.

FIG. 4a illustrates in greater detail the QoS scheduler 18 shown in FIG. 1 to comprise a system for receiving classified frame flows 23 and managing the enforcement of QoS policy contained in a policy database 25 by using the per-flow queueing method traffic. Scheduler 18 is an algorithmic mechanism that enforces QoS requirements on the flows (connections). As a matter of fact, in an exemplary embodiment of the present invention there can be two (or more) QoS schedulers in the policy enforcer 10: one for inbound traffic and another for outbound traffic, but for the sake of simplicity we will refer to it as if we are speaking of only one scheduler since their manner of function is the same in any direction.

Generally speaking, scheduler 18 makes two types of major decisions:

1. it chooses the most prioritized flow (the one that has more rights to transmit frames than any other flow) from schedule queue 29; and

2. it decides whether the chosen flow should actually be allowed to transmit a frame for each given moment based upon two main considerations: [a] determining whether an interface is overflowing, i.e. bandwidth is used up for the moment, and [2] deciding whether a Maximum bandwidth limitation is reached for that particular flow/VC/pipe.

There are four underlying factors that contribute to the process for making both decision:

1. On one hand, flows that have minimum guaranteed bandwidth must be allowed to transmit with minimal delay.

2. On the other hand, the scheduler 18 must make sure that total bandwidth of the frames being fed into the interface 31 at any given moment, is not greater that the total capacity of the interface and that maximum bandwidth allocations are not surpassed.

3. Spare (non-guaranteed) bandwidth must be fairly divided between active flows.

4. And finally, bandwidth must be as fully utilized as possible at any given moment.

With reference now to FIGS. 4a-4h, there is described scheduler 18 becomes active as a result of one of the following events (whichever happens first):

With reference to FIG. 4a, when a scheduling timeout 70 occurs, scheduler 18 checks whether a time slice is over. If a time slice is over, i.e. a set period of time has lapsed, all flows from Max queue 27 are reloaded 71 into schedule queue 29. Counters for allocated BW, spare BW, total weights, and sent-bytes on all levels (interface, pipes, VCs and flows) are refreshed 72 and scheduling weights on all levels are then refreshed and the schedule queue 29 is reordered, i.e. resorted. Scheduler 18, then finishes and waits for either the next scheduling timeout 70 or for a new frame to arrive 74.

If scheduling timeout 70 occurs and the time slice is not over, all flows from Max queue 27 are reloaded 73 into schedule queue 29. If schedule queue 29 is empty then scheduler 18 finishes and waits for either the next scheduling timeout 70 or for a new frame to arrive 74. If scheduler queue 29 is not empty then scheduler 18 checks to see if the interface 31 is fully utilized, and, if not, it handles the most prioritized flow as described below in FIG. 4c. If the interface 31 is fully utilized then scheduler 18 finishes and waits for either the next scheduling timeout 70 or for a new frame to arrive 74.

When a new frame arrives 74 into scheduler 18 from bridge 12 after the classification stage, scheduler first checks to see whether a timeslice is in progress or is over. If the timeslice is over, then the new frame is added to the tail of the send queue of the appropriate flow (see description of FIG. 4b) and the flow is added to the schedule queue 29. If the timeslice is still in progress, then scheduler 18 checks 75 to see if this instance is the first activation of the new frame's flow in the present time slice. If it is, then the counters for allocated BW, spare BW, total weights and sent-bytes relevant to this flow are refreshed and then the current utilization of interface 31 is checked 77. If the flow was already active, then the counters are not refreshed before checking interface 31 utilization. If the interface 31 is fully utilized, then the frame is added 78 to the flow's send queue and the flow is added to schedule queue 29. If the interface 31 is not fully utilized, then scheduler 18 handles the current flow as described in detail in FIG. 4e.

With reference to FIG. 4b, there is seen the hierarchical structure and relationships of schedule queue 29 and send queues 80 within the schedule queue 29. First the pipes 82 are arranged from highest priority to lowest, according to the rules for prioritization discussed herein. Next, within each pipe 82, the VCs 84 are similarly arranged according to priority from highest to lowest. Within each VC 84, the flows 86 are also prioritized and the stream of frames 88 within the thus-assembled flows comprise the send queue 80. After each round of reprioritization, the first frame of the highest priority flow, within the highest priority VC within the highest priority pipe is the next in line to be sent on it's way to its destination. Reprioritization according to the rules described further hereinbelow takes place after each frame is sent.

With reference to FIGS. 4c and 4d, it is seen how scheduler 18 handles the most prioritized flow after reaching box 90. Scheduler 18 first checks to see if the maximum BW specified by the enforcement policy for the pipe of the flow in question has already been reached. If not, scheduler 18 makes the same determination as to the VC of the flow and then, if not exceeded, whether the flow itself exceeds the policy maximum for that particular flow. If none of these maximums were exceeded, then the frame is sent according to the flow chart seen in FIG. 4d. If any of the maximums were exceeded, then the flow is immediately removed from the schedule queue 29 and added to the Max queue 27 for future treatment in the next round or succeeding rounds of reprioritization.

With reference to FIGS. 4a, 4b and 4d, the first 81 frame from the flow's send queue 80 is sent to its destination and the sent bytes statistics are updated for the flow 92, VC 93, pipe 82 and interface 31. Scheduler 18 then checks to see if there are more frames from flow 92 on the send queue 80. If not, then the flow 92 is deleted from the schedule queue 29, and if so then the flow is reweighed and repositioned in schedule queue 29 according to its new weighting. Now referring back to FIG. 4a, schedule queue 29 is consulted 94 to see if it's empty where the process is repeated.

With reference to FIGS. 4a, 4e and 4f, once scheduler has checked 77 to make sure that interface 31 is not fully utilized, total Pipe BW is calculated. If total Pipe BW is not exceeded, then total VC BW is checked, and if that is not exceeded then total flow BW is checked. If none of these are exceeded, then the frame is sent according to the process in FIG. 4f. If any of these parameters is exceeded, then scheduler 18 adds the new frame to the tail of the flow's send queue 80 and the flow is added to schedule queue 29 With reference to FIG. 4f, scheduler 18 checks to see if there are frames on the flow's send queue 80. If not, then a new frame is sent. If there are, then the first frame 81 from the flow's 92 send queue 80 is taken and sent to its recipient. Scheduler 18, then updates the sent bytes statistics for flow, VC, and pipe of the sent frame as well as the interface. If the frame that was sent did not originate from the send queue, the process simply returns to the beginning to await a new frame's arrival or schedule timeout event. If the sent frame came from the send queue 80, then the new frame is added to the tail of the flow 92. The weight of the new frame's pipe 93 is then rechecked for possible repositioning within the schedule queue relative to the other pipes. Similarly, the weight of the new frame's VC is rechecked for possible repositioning within the pipe relative to the other VCs, and the same is true with respect to the flow, which is also checked with respect to its position relative to it's fellow flows within it's VC.

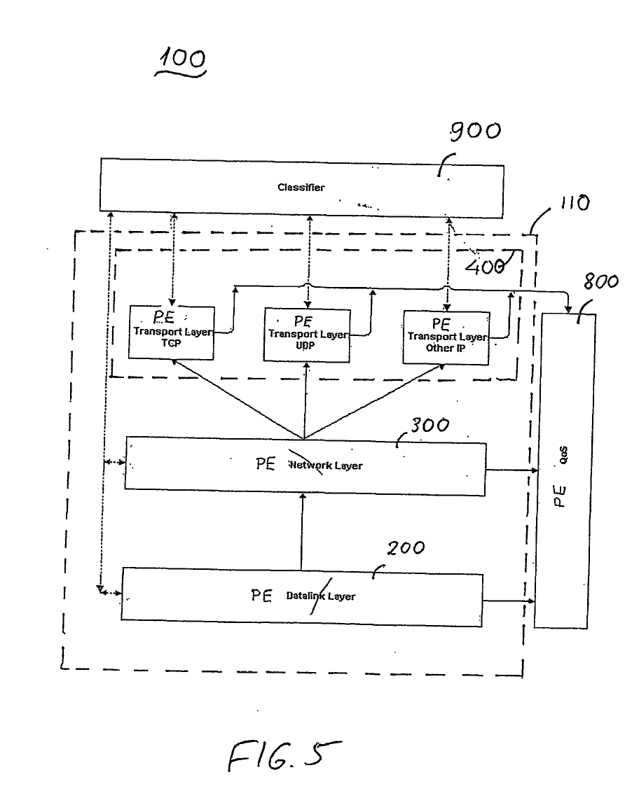

With reference to FIGS. 5-10, another exemplary embodiment of the present invention is described hereinbelow. According to the communication protocols supported by this invention, communication between a client and a server calls for the establishment of connections for each successfully initiated communication request. The connection permits bi-directional data communication: from a client to a server, and from a server to a client, passing through this inventive system in both cases. Typically, the communication volumes in the two directions are very different. According to this invention, the communication traffic in both directions is controlled by the Policy Enforcer (PE), according to criteria set by supervisors, processed by the Policy Manager (PM) and transmitted to the PE. The communication in each direction of a connection is classified separately and could be classified differently.

Numerous connections typically emanate from a LAN or lead into it, and are dynamically established and deleted, as needed by the requests. The resource allocation to the connections according to this preferred embodiment will be elaborated below, although it is to be understood that other ways of priority allocation are also possible, and can be conveniently devised.

Pipe includes the total BW allocated to a user, said BW could vary according to the BW demands of other users. Each user's pipe BW is distributed among its rules, each rule groups a number of connections.

Each rule is characterized by at least one of three parameters for the dynamic determination of its communication resources:

Minimum rule BW.

Maximum rule BW

Rule priority.

Each connection within a rule is characterized by at least one of three parameters which control the resources to be allocated to it within its rule:

Minimum connection BW.

Maximum connection BW.

Connection priority.

Various communication handling parameters, such as the connections' and the rules' BW's, are determined every time bracket. The duration of a time bracket could be selectable and is often taken as one second. “Minimum connection BW” according to this invention guarantees that the minimum BW times the duration of a time bracket will be provided to the connection during each time bracket. It does not necessarily guarantee a constant rate during that time bracket. No account is taken in this embodiment of any additional BW that may have been provided in a previous time bracket to that connection, although it is possible to take previously allocated BW's into account in other embodiments.

Similarly, “Maximum connection BW” guarantees that the maximum BW times the duration of a time bracket, typically one second, will not be exceeded by the connection during each time bracket, and if numerous “maximum connection BW” connections share the same BW, the share of each “maximum connection BW” connection will decrease. It does not necessarily guarantee a constant rate during that time bracket. No account is taken in this embodiment of any additional BW that may have been provided in a previous time bracket, to that connection.

The priorities of the connections classify them and control the distribution of the remaining BW of the rule that was not allocated according to “max connection BW” or “min connection BW”, among its connections, as is explained hereinbelow.

Connections of equal priority, equal minimum connection BW or equal maximum connection BW are grouped in rules.

The BW allocated to each rule, in this embodiment, comprises two parts:

Guaranteed.

Variable, according to priority.

The guaranteed BW's of the rules of a user are added. Any remaining pipe BW is divided among the rules according to their priorities. In this embodiment there are ten priorities, numbered one to ten, and the remaining BW is divided among the rules according the ratio between each rule's priority number and the sum of all of the rules priority numbers. This operation is repeated at the beginning of each time bracket. Other algorithms could be conveniently devised and applied.

A description of the procedure adopted in this embodiment for the handling of queued connections follows. First it should be noted that for a lightly loaded system there is no need to queue connections. An immediate, unqueued communication procedure is adopted, of which one possible procedure is shown below.

When the communication system is relatively heavily loaded, connections in this invention are queued in different queues according to their classes and their protocols, and are processed according to selected algorithms. It should be understood, however, that numerous other algorithms and procedures could be adopted, without deviating from the spirit of this invention. As implemented in this embodiment, the connections within a rule are allocated their BW's, in this invention, according to an algorithm similar to the one used for BW allocation among rules. All of the connections that have a particular guaranteed minimum connection BW are bound together to form a rule. As long as the sum of their BW's does not exceed the rule's BW, more connections may be added to the rule and to its schedule queue, to be communicated at the rate of their allocated BW.

As new connections are being continuously created and as existing connections are terminated, the rule's BW, and the BW allocated to each connection, vary after each time bracket. As long as the rule's BW is not exceeded, the remaining BW of this rule is divided among its connections. The connections queued in the schedule queue are then communicated. Once the sum of a rule's connections BW's exceeds their rule's BW for the current time bracket, any new connections are added to a blocked queue, to be handled in the next time bracket, when more BW becomes available.

Once classified and prioritized, these connections may be logically grouped according to their priorities, or according to any other criteria, into rules, wherein connections in each equal priority group are handled equally, according to pre-selected, dynamically applied criteria of each priority.

Several rules may exist for each user's LAN, each rule with its own priority. The logically banded rules of a LAN are included in a pipe, wherein a pipe is allocated all of the user's allocated BW.

While a two-tiered grouping, or division, is discussed in this embodiment, i.e. connections are low-tiered grouped to form rules and rules are high-tiered grouped to form pipes, other numbers of tiers could also be used, if so desired. This multi-tiered grouping of connections facilitates the equitable resource allocation among both the different priority rules and within each rule, as shown.

The classification of IP protocol communicated flows for their prioritization can be carried out either by analyzing some or all of the IP packets' five header fields, by analyzing the transmitted data within the packet, such as by checking the occurrence of selected keywords within the data, or by analyzing both. Addressing now classification methods based on any or all of the header fields, the classification according to this invention can be carried out by analyzing both the source fields and the destination fields, thus criteria applied to the requesting unit, also called “source”, and to the destination unit, called “destination”, can be taken into account.

As each LAN's connections are being continuously generated and deleted, so are the available communication resources to the LAN's and those used by them. Therefore the efficient resource allocation calls for dynamically monitoring and changing the LANs' allotment among the connections according to selectable policies, which can change according to supervisors decisions.

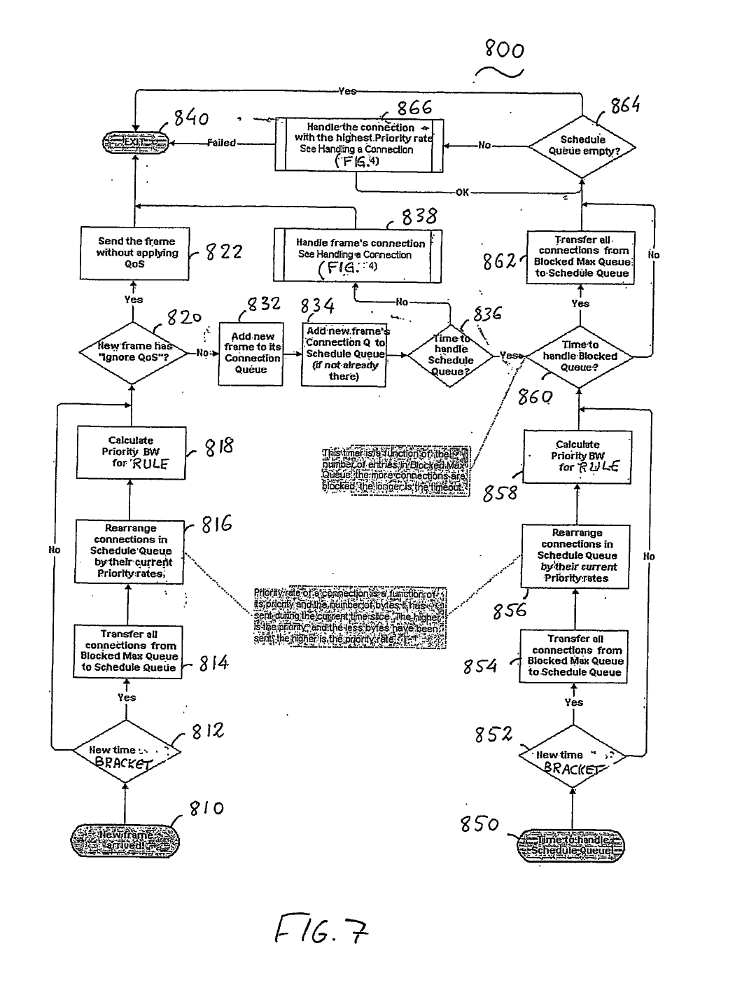

Referring to FIG. 5, a depiction of a block diagram 100 showing the main blocks of this PE inventive system and method. Using the well known seven-layer terminology, 200 is the data link layer block of this invention, communicating into the network layer block 300 or into a QoS block 800, as shown hereinbelow. Block 800 is shown in more detail in FIGS. 7-10. Network layer block 300 communicates with several sub-modules, said sub-modules comprise the transport layer block 400, and each frame reaching 400 is handled by one of its sub-blocks, according to said sub-block protocol, said sub-blocks of this embodiment are:

IP sub-block 420,

UDP sub-block 440, and

TCP sub-block 460.

Each one of protocols sub-blocks 420, 440, 460:

forms a logical path for frames of its respective protocol.

communicates with block 800 and with another unit 900, which does not form part of this invention.

Other protocols sub-blocks, for the handling of other protocols' frames, may be added, and any of the abovementioned protocols 420, 440, 460 may be removed, if so desired.

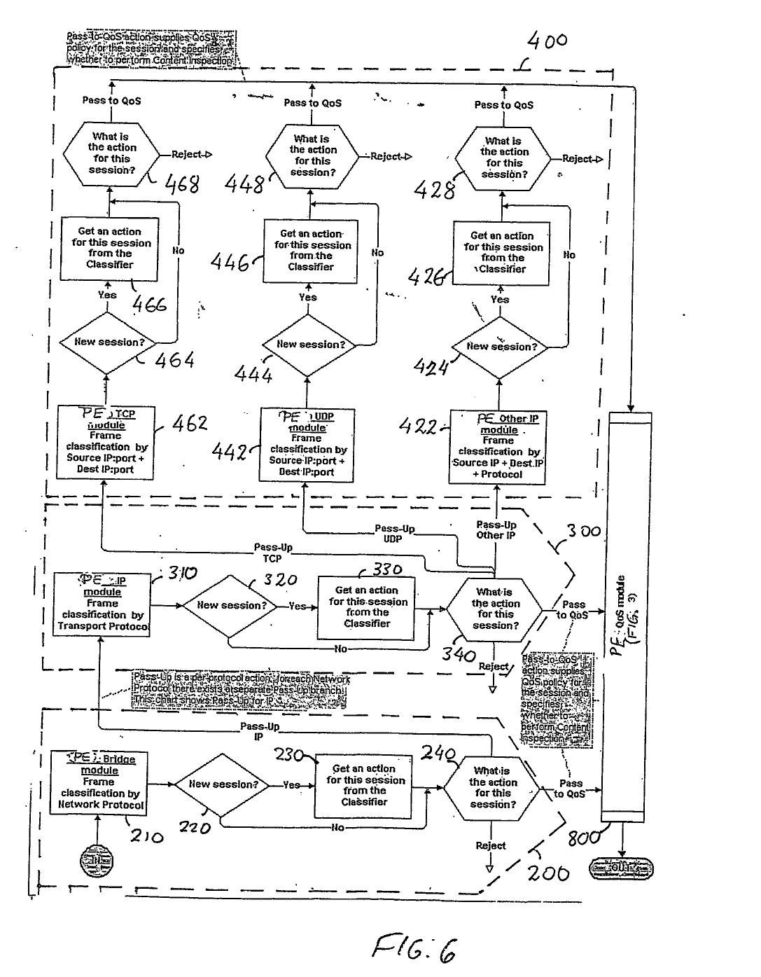

Referring now to FIG. 6, which is a more detailed depiction of some of the blocks and the sub-blocks of this inventive system 100 preferred embodiment. Block 200 first identifies the type or the protocol of each flow of the traffic reaching the system. It then determines the action for the flow. The three protocols supported by this embodiment are those in the current widest use, namely:

IP, referred to in sub-block 420 of FIGS. 5,6,

UDP, referred to in sub-block 440 of FIGS. 5,6, and

TCP, referred to as sub-block 460 in FIGS. 5,6.

Other protocol sub-blocks may be added if needed.

The building blocks and the steps followed by a frame in datalink layer block 200 are as follows:

Block 200, comprising a bridge module 210 which identifies a frame, followed by step 220 which determines whether a session for the flow of this frame already exists or a new session is to be started. If a session does not exist then this is the first packet of a frame, a new session is opened, a connection is established and the frame proceeds to step 230 wherein it gets an action from classifier 900, shown schematically in FIG. 5. Subsequent packets of a session are identified and attributed to their existing sessions and use their already determined actions. Then step 240 checks one of three possible actions for that session:

Reject.

Pass to QoS module 800.

Proceed to block 300 for further handling.

A frame reaching block 300 is then checked in step 310 by the transport protocol. Step 320 determines whether a session for the flow of this frame does not exists, i.e. whether this is a new session, or a session and its connection already exists. A frame of a new session proceeds to step 330, in which an action is determined and received and then said frame proceeds to step 340, to which a frame of an existing session proceeds directly from step 320. Then step 340 checks the action for that session, which could be one of three:

Reject.

Pass to QoS module 800.

Proceed to block 400 for further handling.

Sessions reaching block 400 branch into one of several branches, one branch per protocol. Block 400 of this preferred embodiment comprises three branches:

Branch 420, handling IP sessions,

Branch 440, handling UDP sessions, and

Branch 460, handling TCP sessions.

Other branches, for the handling of sessions of other protocols not referred to in the detailed description of FIGS. 5, 6, may be added to module 400, and any branch listed hereinabove may be removed, if so desired. The sections of the block diagram of FIG. 6 depicting the main steps for the handling of a frame by each one of the abovementioned branches are similar. A frame reaching a branch is forwarded to one of sub-modules 420, 440, 460, according to its protocol. It then proceeds to one of steps 422, 442, 462, respectively, identifying the session of that frame, from which It proceeds to one of steps 424, 444, 464, respectively, in which it is determined whether this is a new session or not. Frame of an old session proceeds to one of steps 428, 448, 468, respectively, while a new session frame proceeds to one of steps 426, 446, 466, respectively, in which it gets further policy-related data from unit 900, not shown here. A new session's frame then proceeds to one of steps 428, 448, 468, respectively, said steps determine whether it should proceed to module 800, described in more detail in FIGS. 7-10, or be rejected.

Referring now to FIG. 7, depicting a block diagram of a preferred embodiment of block 800, providing the required QoS for the handling of frames. Other embodiments, utilizing different methodologies could be adopted, and numerous adaptations to the presented methodology are possible as can be readily observed by those skilled in the art.

This inventive system determines a LAN's connections' priorities according to their attributes, by means of another inventive system, then binds equal priority connections into rules and groups all of the rules of a LAN into a pipe. The LAN's resources are allocated to a pipe and divided among the rules. All of the connections of a rule have the same priority, i.e. each one of them may transmit an equal number of bytes during a time bracket. Although the transmission rates within a bracket may vary.

A description of the prioritizing methodology adopted in this embodiment precedes the description of FIG. 7.

Connections may be grouped according to one of three possible guarantee levels of number of bytes per second:

Guaranteed minimum number of bytes.

Guaranteed maximum number of bytes.

Priority.

Connections may be added to a rule as long as the rule has available BW for their handling. The connections of a rule are then added to queues and communicated according to the allocated BW. Furthermore, if the load on the communication system is low, then a newly arrived frame is communicated directly, without being queued, as shown hereinbelow.

Two queues are provided for the queuing of connections and their frames:

A schedule queue for the handling of connections to be transmitted during the current time bracket.

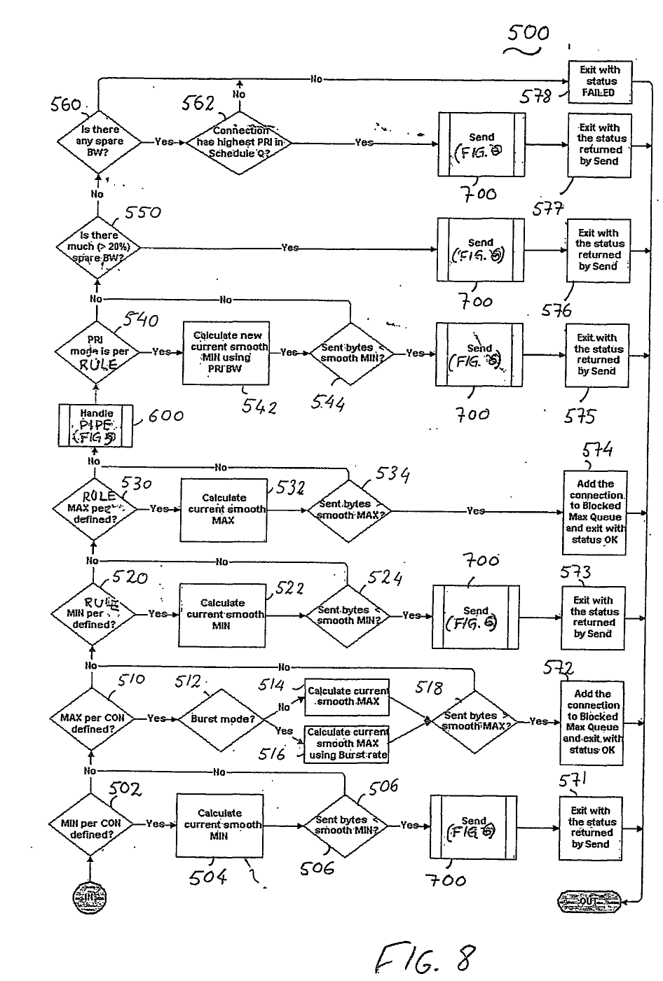

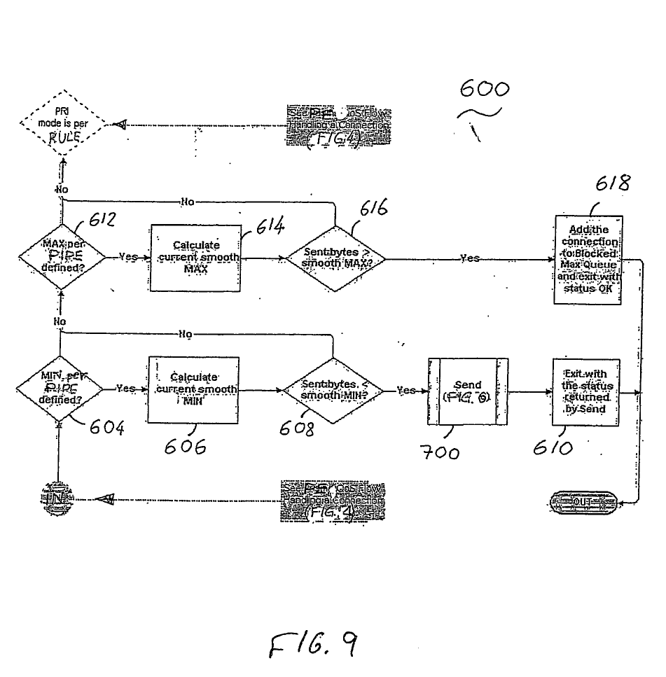

A blocked queue, further elaborated in FIGS. 8, 9, for the handling of connections whose requirements exceed the resources allocated to their rules during the current time bracket. Also handled by the blocked queue are connections that exceed the schedule queue capacity.

Block 800 comprises two interconnected branches:

One branch, starting at step 810, and referred to hereinbelow as branch 810, handles newly arrived frames, and either transmits them directly or adds them to queues, according to the system load, as shown hereinbelow.

The other branch, starting at step 850 and referred to hereinbelow as branch 850, handles queues of old frames queued in a schedule queue or in a blocked queue, to be elaborated below.

The procedures for the handling of newly arrived frames or of queued frames are repeated at each time bracket.

Returning now to a detailed description of branch 810, a new frame reaches step 810. Step 812 then checks whether a new time bracket commences.

If a new time bracket commences, then:

(1a) Transfer all blocked queue connections to schedule queue, step 814.

(1b) Rearrange all of the connections in the schedule queue in rules according to their priorities, step 816.

(1c) Calculate new priority BW for the rules, step 818.

If a new time bracket has already started, then check if the new frame is marked as “ignore QoS”, step 820. If yes, then:

(2a) Send the new frame directly, bypassing any queue, step 822, then:

(2b) exit, step 840.

If the new frame is not marked as “ignore QoS”, then:

(2c) Add the new frame to its connection queue, step 832.

(2d) Add new frame's connection queue to schedule queue, step 834.

Check in step 836 if it is time to handle schedule queue. If step 836 is “no”:

Go to step 838: proceed to handle the frame's connection, FIG. 8. If step 836 is “yes”, i.e. it is time to handle schedule queue, then:

Go to step 860 of branch 850, joining branch 850 and proceeding with it from there.

In step 860, branch 850, check if it is time to handle blocked queue. If no:

(1) go to step 864 and check whether schedule queue is empty or not.

(1a) If the schedule queue is not empty, proceed to step 866, further elaborated in FIG. 8, for handling connections.

(1b) If the schedule queue is empty, exit, step 840.

In step 860, if it is time to handle blocked queue then:

(2) go to step 862 wherein:

blocked queue connections are transferred to schedule queue, Then go to steps 864, 866, 840 as shown hereinabove.

Referring now to FIG. 8, describing a detailed block diagram of a preferred embodiment of connection handling 500 by QoS block 800 of this inventive system.

A newly arrived frame is tested at 502 whether a minimum connection BW is defined for it.

If minimum connection BW is defined, then:

calculate the current smoothed minimum byte number allocated to it as a simple ratio of the elapsed time since the beginning of the current time bracket times the allocated connection BW per time bracket, divided by the time bracket duration, step 504.

Test in step 506 if the number of sent bytes is lower than the current smoothed minimum. If it is lower, then:

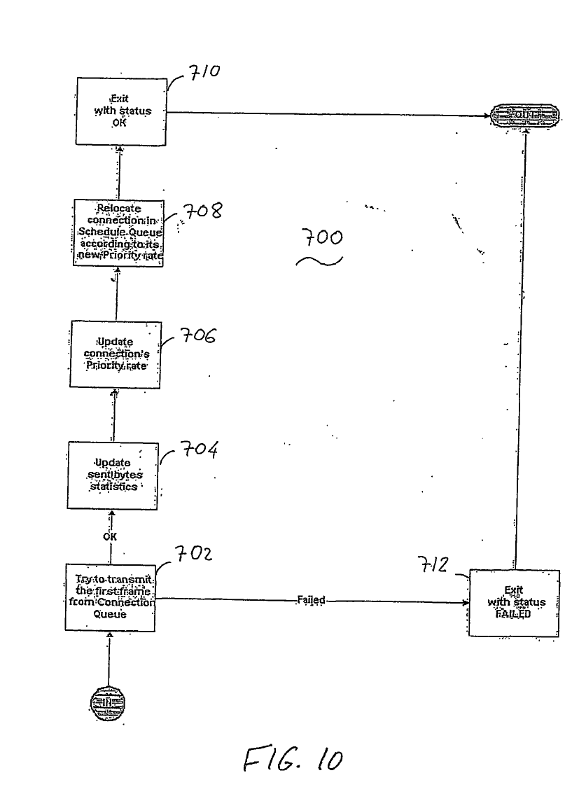

send more, as shown in block 700, FIG. 10, then exit, step 571, with the status as returned by 700.

If minimum connection BW is not defined, or if the number of sent bytes is higher than the smoothed minimum as calculated in step 504, then go to step 510 testing whether a maximum connection BW is defined. If maximum connection BW is defined, then further check whether a burst mode is defined for this frame. A burst mode is defined hereinbelow as a mode in which the smoothed minimum may be exceeded, as is necessary, as long as the total BW of this connection is not exceeded within a bracket.

If a burst mode is defined then calculate smooth maximum number of bytes based on burst mode, step 514.

If a burst mode is not defined then calculate smooth maximum number of bytes, step 516.

In step 518, check whether the number of sent bytes exceeds the number of smooth maximum number of bytes, as calculated in either step 514 or 516.

If the number of sent bytes exceeds the smooth maximum number of bytes, add the connection to a blocked queue, step 572.

If the number of sent bytes does not exceed the smooth maximum number of bytes, proceed to step 520 wherein it is tested whether a minimum rule BW number of bytes is defined.

If a minimum rule BW number of bytes is defined, then:

calculate the current smoothed minimum rule number of bytes allocated to this rule as a simple ratio of the elapsed time since the beginning of the current time bracket, times the rule allocated BW per time bracket, divided by the time bracket duration, step 522. Then check whether the smoothed minimum rule number of bytes is lower than the number of sent bytes, step 524.

If the smoothed minimum rule number of bytes is higher than the number of sent bytes, then:

go to step 700 and send, then proceed to step 573 and exit with the status as returned in step 700.

If the smoothed minimum rule number of bytes is lower than the number of sent bytes, then:

proceed to step 530, wherein:

test whether a max rule BW is defined. If a rule maximum number of bytes is defined, then calculate, in step 532, the smooth maximum number of bytes, then further check, in step 534, whether the number of sent bytes exceeds the smooth rule maximum number of bytes, as calculated by multiplying the ratio of the elapsed time since the beginning of the current time bracket times the maximum rule allocated BW per time bracket, divided by the time bracket duration. If it does, then add the connection to blocked maximum queue and exit with “OK” status.

If a rule maximum number of bytes is not defined, then:

move to step 600, further elaborated in FIG. 9 hereinbelow for the handling of pipes, then move to step 540 and test if a priority mode is defined per rule.

If a priority mode is defined per rule then calculate a new current smooth minimum using the priority BW, step 542, then proceed to step 544 and check whether the calculated new current smooth minimum using the priority BW is higher than the number of sent bytes. If it is, then send, step 700, further elaborated in FIG. 10, and exit with the status as returned by send, step 575.

If, according to step 544, the calculated new current smooth minimum using the priority BW is lower than the number of sent bytes, or if a priority mode per rule is not defined in step 540, then move to step 550 to check if there is much spare BW, which could be defined as more than 20% of the total BW, or as any other selectable number.

If there is much spare BW, as checked in step 550, then send, step 700, further elaborated in FIG. 10, and exit with the status as returned by send, step 576.

If there is not much spare BW as checked in step 550, then check whether there is any spare BW, step 560. If there is any spare BW then check whether this connection has the highest priority in the schedule BW, step 562. If it has, then send, step 700, and exit with the status returned by 700.

If there is no spare BW, as checked in step 560, or if the connection does not have the highest priority in schedule queue, step 562, then exit with a failed status, step 578.

Referring now to FIG. 9, describing the details of block diagram 600 of a preferred embodiment of pipe handling by QoS 800 of this inventive system.

When a connection reaches block 600, a test is conducted to find out whether a minimum BW per pipe is defined, step 604. If a pipe minimum number of bytes is defined, then calculate, in step 606, the smooth minimum number of bytes, by multiplying the elapsed time since the beginning of the current time bracket times the minimum pipe allocated BW per time bracket, divided by the time bracket duration, then further check, in step 608, whether the number of sent bytes is lower than the smooth pipe minimum number of bytes. If it is lower, then send, step 700, further elaborated in FIG. 10, and exit, step 610, returning the status as generated by 700.

If a pipe minimum number of bytes is not defined, as tested in step 604, or if the number of sent bytes is higher than the smooth pipe minimum number of bytes, as tested in step 608, then go to step 612 to test whether a pipe maximum BW is defined. If a pipe maximum number of bytes is defined, then calculate, in step 614, the smooth maximum number of bytes by multiplying the elapsed time since the beginning of the current time bracket times the maximum pipe allocated BW per time bracket, divided by the time bracket duration, then further check, in step 616, whether the number of sent bytes is higher than the smooth pipe maximum number of bytes. If it is higher, then add the connection to blocked max queue and exit with “OK” status, step 618.

If, according to step 612 a pipe maximum number of bytes is not defined, or if the number of sent bytes is lower than the smooth pipe maximum number of bytes, step 616, then go to step 540, FIG. 8, and proceed from there, as shown hereinabove.

Referring now to FIG. 10, a block diagram 700 of the send procedure, when a connection reaches block 700 an attempt to send the first frame from the schedule queue is made, step 702. If it fails then exit with “failed” status, step 712, and then to out, step 714. If the transmission is successful, then update sent byte statistics, step 704, update connection priority, step 706, and relocate the connection in a schedule queue, according to its new priority, step 708, then exit with status “OK”.

This description of a preferred embodiment is presented hereinabove in order to enable a person of ordinary skill in the art to design, manufacture and utilize this invention. Various modifications and adaptations to the preferred embodiment will be apparent to those skilled in the art, and different modifications may be applied to different embodiments. Therefore, It will be appreciated that the invention is not limited to what has been described hereinabove merely by way of example. Rather, the invention is limited solely by the claims which follow this description.

What is claimed is:

1. A method for dynamically apportioning network bandwidth in real-time comprising rebalancing the weights of each remaining flow in a schedule queue after each frame is sent.

2. A network comprising a frame delivery schedule system for weighting and timing the delivery of frames from flows according to user-definable policies, comprising a scheduler, said scheduler comprising a schedule queue, and a policy database, said scheduler further comprising an algorithm whereby each queued flow is weighted at least once and wherein a flow having frames waiting to be sent is re-weighted after one of its frames is sent.

3. A network according to claim 2, wherein each policy defines a frame grouping selected from the group consisting of a pipe, a VC or a flow.

4. A network in accordance with claim 2, wherein said queued flow is carried in a pipe and wherein said re-weighted flow is resorted within said pipe.

5. A network in accordance with claim 2, wherein said flow is contained in a policy-defined VC, and said policy-defined VC is contained in a policy-defined pipe.

6. In a computer network comprising processing units, said processing units including a plurality of client computers, at least one server and at least one policy enforcing means, wherein:
at least one domain is formed by the operative interconnection of said at least one server with said plurality of client computers, by forming connections for the transfer of data between said client computers and said at least one server, both intra domain and inter domain,
one of several priorities is allocated to each connection,
variable communication resources are dynamically allocated to said at least one domain,
successive time brackets of a selectable duration are established,
a schedule queue for connections is established,
a blocked queue for connections is established,
a method for the multi-tiered optimized allocation of communication resources among said connections according to selectable policy for the determination of priorities of said connections, said method comprises of:
binding of equal priority connections of a domain to form a rule, said rule having a priority determined by a selectable policy;
binding of rules of a domain to form a pipe of a domain;
continuously monitoring the usage and the metrics of each one of the connections of said network domains;
dynamically allocating communication resources to said at least one pipe of a domain,
dynamically allocating communication resources of a pipe among said rules forming at least one pipe of a domain according to the priority of each rule,
dynamically allocating communication resources of a rule among said equal priority connections forming said rule,
wherein said dynamic allocating of communication resources is repeated at least at the beginning of each time bracket of a selectable duration.
